(19) United States
(12) Patent Application Publication
(10) Pub. No.: US 2008/0098480 A1
(43) Pub. Date: Apr. 24, 2008

(54) INFORMATION ASSOCIATION

(75) Inventors: Shaun P. Henry, Middleton, ID (US); Robert M. Sesek, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/551,343

(22) Filed: Oct. 20, 2006

(51) Int. Cl. H04N 7/16; H04L 9/32; G06F 17/30; G06F 12/14; G06F 7/04; G06K 9/00; G06F 11/30; H03M 1/68; H04K 1/00; H04L 9/00

(52) U.S. Cl. 726/26; 726/27; 726/30; 713/189

(57) ABSTRACT

A method and apparatus associate different characteristics with different information portions and selectively distribute or provide access to the different portions based on the different characteristics associated with the portions.

### BACKGROUND

A single record may include different portions of information. Selectively distributing the different portions to different individuals or selectively providing access to the different portions is difficult.

### BRIEF DESCRIPTION OF THE DRAWINGS

FIG. 1 is a schematic illustration of an information system according to an example embodiment.

FIG. 2 is a schematic illustration of a first embodiment of an information capture component of the system of FIG. 1 according to an example embodiment.

FIG. 3 is a schematic illustration of a first embodiment of an information capture component of the system of FIG. 1 according to an example embodiment.

FIG. 4 is a top perspective view of a non-digital record having non-substantive characteristics associated with information portions according to an example embodiment.

FIG. 5 is a schematic illustration of a third embodiment of an information capture component of the system of FIG. 1 according to an example embodiment.

FIG. 6 is a block diagram illustrating an example process that may be carried out by the information system of FIG. 1 according to an example embodiments.

### DETAILED DESCRIPTION OF THE EXAMPLE EMBODIMENTS

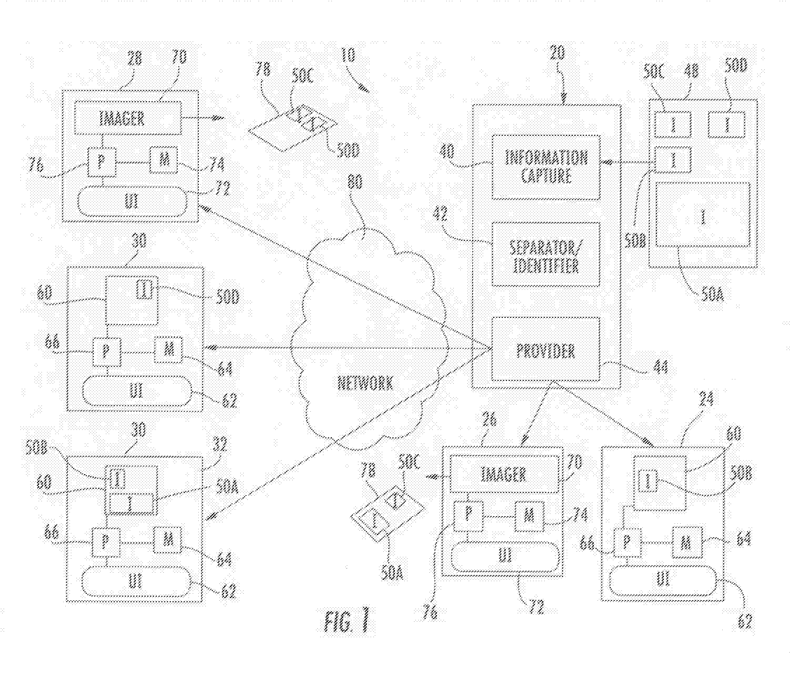

FIG. 1 schematically illustrates information system 10. System 10 is configured to selectively distribute or selectively provide access to different portions of information contained in a record based upon different characteristics assigned linked or otherwise associated with the different portions of information. System 10 facilities and simplifies automatic allocation of information to different parties or persons.

System 10 generally includes association device 20 and recipients 24, 26, 28, 30 and 32. FIG. 1 illustrates a functional block diagram of association device 20. Association device 20 receives or captures information, separates different portions of the information based upon different characteristics associated with the different portions of information and selectively provides, distributes or provides access to, the different portions of information.

As shown by FIG. 1, association device 20 includes information capture component 40, separator/identifier component 42 and provider 44. Information capture component 40 comprises that portion of device 20 configured to input, recognize, sense, read or otherwise capture information contained in a digital record. For purposes of this disclosure, a “digital record” shall mean a digital medium, such as an electronic file or computer-readable medium containing or storing computer readable data configured to be read by a computing device, wherein the computing device may visibly present information portions 50 to a person or party using a display or may print the information portions 50 to a “non-digital medium” shall mean a medium upon which information may be written so as to be visible to the human eye and so as to be read or viewed by a person without electronic assistance. For purposes of this disclosure, unless otherwise specified, the term “written” shall encompass any method by which ink, toner, lead, graphite, or other materials are marked or otherwise applied to a non-digital medium. For example, in one embodiment, information portions 50 may be hand written upon a sheet may be typed, printed, stamped or otherwise imaged upon a sheet.

In one embodiment, record 48 may comprise a document created with work processing software, such as a Microsoft® Word® Word® document. In other embodiments, record 48 may comprise other electronic files or computer readable mediums having other formats in which information is stored for subsequent presentation. In the example illustrated, record 48 includes information portions 50A, 50B, 50C and 50D (collectively referred to as portions 50). Information portions 50 each generally comprise distinct pieces of information intended to be provided to different persons or parties. Such information may be in the form of text (alphanumeric symbols) and may additionally or alternatively be in the form of text (alphanumeric symbols) and may additionally or alternatively be in the form of graphics (drawings, illustrations, graphs, pictures and the like) that is generally visible to the human eye when presented on a display or printed to a non-digital medium.

Information portions 50 in record 48 each have different associated non-substantive characteristics. For purposes of this disclosure, a “non-substantive characteristic” is a characteristic that is unrelated to the message or information being presented. Examples of non-substantive characteristics include different text fonts (i.e., Times new Roman, Arial), different text font styles (i.e., italic, bold), different text font sizes (i.e., 10 point, 12 point and so on), different text font effects (i.e., shadow, outline, emboss, engrave, small caps—provided in Microsoft® Word®), different text effects (i.e. blinking background, shimmer, sparkle, marching ants—provided in Microsoft® Word®), different character spacings (i.e., the spacing between individual letters or numbers), different hand writings styles, different sound or speech characteristics (i.e., when text is dictated using voice or speech recognition software, wherein the sound characteristics used to dictate the text is associated with the text), different text or graphics selection styles (i.e., text or graphics being selected by being enclosed within a circle, enclosed with an oval, enclosed within a square, and the like), different text or graphics colors and different text or graphics highlight. Unlike particular combinations of letters, numbers or graphics or the layout and relative positioning of letters, numbers or graphics which convey information in the form of words, numbers and pictures, such non-substantive characteristics have little or no substantive content by themselves. As will be described in more detail hereafter, these non-substantive characteristics are assigned or associated with different information portions 50 as a way to distinguish one collective group or piece of information from other groups are pieces of information and may to serve as a vehicle for assigning an identity to different information portions 50, enabling information portions 50 to be selectively provided to different recipients using provider rules.

Information capture component 40 is configured to capture or read information portions 50 from a digital record 48. In one embodiment, information capture component 40 may comprise firmware or software associated with a processing device or processing unit that directs a processing unit to read information portions 50 stored in a computer readable memory, such as wherein record 48 comprises a computer readable file in which information is digitally stored. In another embodiment, information capture component 40 may additionally be configured to facilitate creation of digital record 48. For example, component 40 may comprise one ore more elements or devices facilitating input of information portions 50 which component 40 then stores in a digital record 48. For example, information capture component 40 may comprise a user interface by which such information may be input and recorded to a digital record 48. Examples of user interfaces include, but not limited to, keyboards, microphones and voice or speech recognition software, a mouse, touchpads, touch screens, other devices having sensing surfaces and the like. In yet another embodiment, information capture component 40 may additionally be configured to scan or otherwise sense information portions 50 that have been written upon a non-digital medium so as to be readable from the medium with the human eye and to transfer such information portions into the format of a digital record 48. For example, image capture component 40 may additionally include a scanner, a camera or other device configured to optically capture information portions 50 upon a physical, non-digital record, such as a sheet of paper, and to store such information portions 50 upon a digital file or record 48.

Separator/identifier component 42 comprises that portion of device 20 configured to identify different selected characteristics of information portions 50 and to separate or distinguish information portions 50 from one another based upon their different characteristics. In one embodiment, separator/identifier may additionally be configured to separately store information portions 50. For example, in one embodiment, separator/identifier component 42 may create different digital files, wherein each file contains one of information portions 50. In yet another embodiment, separator/identifier component 42 may tag or otherwise demarcate and identify the different information portions 50 in a digital record 48 to facilitate subsequent independent extraction of information portions 50 from the digital record 48 for selectively providing such information to different persons or parties.

Separator/identifier component 42 may be embodied as firmware or software (computer readable instructions) associated with a processing unit of device 20. For purposes of this application, the term “processing unit” shall mean a processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, component 42 may be embodied as part of one or more application-specific integrated circuits (ASICs). Unless otherwise specifically noted, a processing unit is not limited to any specific combination of hardware circuitry and software, not to any particular source for the instructions executed by the processing unit.

Provider 44 comprises that portion device 20 configured to selectively provide information portions 50 to particular persons, parties or devices. For purposes of this disclosure, the phrase “provide” shall encompass distributing or delivering such information portions as well as providing access to such information portions 50. In one embodiment, provider 44 selectively distributes different information portions 50 to different recipients 24-32 based upon the identified characteristics of such information portions 50 and based upon one or more provider rules.

Provider rules prescribe to whom or how access is to be provided based upon particular non-substantive characteristics being associated with information portions 50. Such provider rules may be predefined prior to separator/identifier component 42 separating and identifying various non-substantive characteristics of information portions or may alternatively be established after separator/identifier component 42 has separated and identified various non-substantive characteristics of information portions 50. Such provider rules may be encoded and stored in a memory of association device 20 or may be input to association device 20 with a user interface (not shown).

One example of a provider rule might be to automatically distribute information portions 50 associated with a first color to a first recipient or first group of recipients and to automatically distribute information portions associated with a second color to a second recipient or second group of recipients. Another example of a provider rule might be to encode all information portions 50 having a particular non-substantive characteristic with a first encoding scheme. Another example of a provider rule might be to encode all information portions 50 having a first particular non-substantive characteristic with a first encoding scheme and to encode all information portions 50 having a second particular non-substantive characteristic with a second encoding scheme.

In one embodiment, provider 44 may be configured to automatically generate and transmit electronic mail to recipients 24-32 upon receiving a send command for record 48. Even through record 48 contains each of information portions 50A-50D, not all of information portions 50 of record 48 would be sent to each of recipients 24-32. Rather, one recipient 24 may receive an e-mail containing or having attached thereto a file including a first set of one or more information portions 50, while another recipient, such as recipient 30, may receive an e-mail containing or having attached thereto a file including a second set of one or more information portions 50.

In another embodiment, provider 44 may provide or deny access to one or more of information portions 50 in record 48 based upon the different characteristics associated with information portions 50 in record 48 based upon the different characteristics associated selected information portions 50 based on their associated characteristics while not encrypting other information portions 50, selectively limiting access or viewing of the encrypted information portions 50 to those having appropriate authorization.

In addition to encrypting and not encrypting information portions 50 based upon their associated characteristics, different information portions 50 may be differently encrypted based upon their identified characteristics. For example, in one embodiment, different levels of encryption may be applied to different information portions 50. In one embodiment, one information portions 50 may be encrypted so as to have a first encryption key while a second information portion 50 may be encrypted so as to have a second distinct encryption key.

In such embodiments, because device 20 automatically encrypts different information portions 50 in the same record 48, additional steps of extracting and separately encrypting information portions 50 by a person may be avoided. Different levels of security may be provided to different information portions 50 in a single record 48 by simply associating different non-substantive characteristics with such different information portions 50. In those embodiments in which information portions 50 are first recorded by being written upon a non-digital medium, such as a sheet of paper, different desired security settings or levels may be applied while writing information portions 50 to the non-digital medium. This may be achieved by doing something as simple as by writing different information portions 50 in different colors, highlighting different non-substantive characteristics to information portions 50 including those identified above. In particular circumstances, different security levels may be prescribed to different information portions 50 of a non-digital record, such as record 348 (shown in FIG. 4), after the information portion 50 have already been written upon a non-digital record 348. For example, it may be determined that a particular non-digital record 348 contains information that should not be made available or provided to selected individuals. Prior to capturing and converting information on the non-digital record 348 to a digital record 48, such as by scanning, a person may highlight the particular information portions 50 with different colors or apply different selection styles or other non-substantive characteristics to the particular information portions, wherein certain individuals, parties or devices may be provided with access to or receive selected information portions 50 and not information portions 50 from a digital record 48 created from the non-digital record based upon the color, selection styles or other non-substantive characteristic associated with the particular information portions 50.

FIG. 1 schematically illustrates various examples of potential recipients for information portions 50 of record 48 as provided by provider 44 of device 20. In the example illustrated, recipients 24, 30 and 32 comprise different computing devices in which information received is displayed. Each of recipients 24, 30 and 32 (schematically shown) includes a display 60, a user interface 62, a memory 64 and a processing unit 66. Display 60 comprises a monitor or screen configured to provide visible text and/or graphics for viewing by an observer. User interface 62 comprises one or more elements facilitating input of commands, selections or instructions. Examples of user interface 62 include, but are not limited to, keyboards, microphones and voice or speech recognition software, a mouse, touchpads, touchscreens, buttons, slides, switches or other devices having sensing surfaces and the like. Memory 64 comprises any of a variety of presently available or future developed persistent memory structures configured to store digital records or files. Processing unit 66 comprises a processing unit configured to generate control signals following instructions in memory 64 and commands received from user interface 62. Such control signals may direct display 60 to display information received from device 20 or stored in memory 64.

Recipients 26 and 28 are substantially similar to one another and comprise printing devices configured to print or otherwise render received information onto a non-digital medium, such as a sheet of paper. Recipients 26 and 28 each comprise a device or component configured to form a viewable or readable image of text or graphics upon the non-digital record. In one embodiment, imager 70 may be configured to apply on or more printing materials, such as ink or toner onto a non-digital medium. Examples of imager 70 include inkjet and electrophotogaphic print engines.

User interface 72 is substantially similar to user interface 62 except that interface 72 provides commands or instructions for processing unit 76. Memory 74 comprises any of a variety of presently available or future developed persistent memory structures configured to store digital records or files. Processing unit 76 comprises a processing unit configured to generate control signals following instructions in memory 74 and commands received from user interface 72. Such control signals may direct imager 70 to print received information upon a non-digital medium 78.

FIG. 1 further illustrates provider 44 of device 20 selectively providing information portion 50 from record 48 to recipients 24-32. As shown by FIG. 1, based upon the non-substantive characteristics of each of image portions 50 as captures by information capture component 40 and as identified and separated by separator/identifier component 42, provider 44 transmits information portions 50B to recipient 24 and information portion 50D to recipient 30. In the example illustrated, information portion 50B is transmitted directly to recipients 24 as a distinct file which omits the other of information portion 50 of record 48. Such direct transmission may be the result of recipient 24 and device 20 being directly associated with one another such as being part of a single computing device. Information portions 50D is transmitted across a network 80 to recipient 30 as a distinct file which omits the other information portions 50 of record 48. Network 80 may comprise an Internet connection or an intranet connection, may be wired or wireless or may have other configurations.

In the example illustrated in FIG. 1, provider 44 further transmit information portions 50A and 50C directly to recipients 26 as a distinct file which omits other information portions 50 of record 48. Such direct transmission may be the result of recipient 26 being directly connected to the computing device having association device 20. In response to receiving information portion 50, processing unit 76 may automatically direct imager 70 to print the file containing information portion 50A and 50C onto non-digital medium 78. In another embodiment, the file containing information portions 50A and 50C may be stored in memory 74 for later printing by imager 70 in response to commands from user interface 72.

FIG. 1 further illustrates provider 44 alternatively transmitting a digital file of the entire record 48 to recipients 28 and 32 via network 80. Although the digital file transmitted to recipients 28 and 32, contains each information portion 50, particular information portions 50 have been encoded by provider 44, restricting access to such information portions. In the example illustrated, recipient 32 provides an encryption key or other authorization input via user interface 62 or previously stored in memory 64 to processing unit 66, and enabling information portions 50A and 50B to be unencrypted and presented by display 60. Recipient 28 provides one or more encryptions keys or other authorization input via user interface 72 or from memory 74 to processing unit 76, allowing information portion 50D to be unencrypted. In the example illustrated, information portion 50C was not encrypted. As a result, information portions 50C and 50D maybe printed upon non-digital medium 78 by imager 70.

Although provider 44 has been described as transmitting entire files to recipients 28 and 32, wherein portions are encrypted and are decrypted by processing unit 66 or processing unit 76, in other embodiments, association device 20 may request an encryption key or other authorization from recipients 28, 32. Upon receiving the requested authorization via network 80, provider 44 may subsequently transmit those information portions 50 of record 48 that have been encrypted or for which authorization must be provided before transmission. Thereafter, the received information portions 50 may be either displayed, printed, or stored in memory 74 or memory 64 respectively.

FIGS. 2-5 illustrate various embodiments of information capture component 40 [There is no“40” label on any if FIGS. 2-5. Even a floating number with a squiggly arrow as used with “10” and “20” in FIG. 1 would be helpful.] and example methods of associating different non-substantive characteristics with different information portions 50 so as to prescribe different security or distribution settings for the different information portions. FIG. 2 illustrates one method wherein different non-substantive characteristics are associated with different information portions 50 using information capture component 140, a computing device. Information capture component 140 is substantially similar to the computing device of recipient 24 described with respect to FIG. 1. In particular, as shown by FIG. 2, a digital record 148 including information portions 150 is presented on display 60. Record 148 may be supplied from memory 64 or may be supplied from another source, such as a disk reader, input port or the like. Initially, information portions 150 as presented on display 60 lack any associated non-substantive characteristics that have corresponding provider rules. According to one embodiment, a person may selectively apply non-substantive characteristics having corresponding provider rules to information portions 50 with associated non-substantive characteristics. For example, in one embodiment, provider 44 (shown in FIG. 1) may follow provider rules to differently encode or differently distribute information portions based upon the color associated with such information portions. In such an embodiment, a person may selectively highlight information portions 150 with particular colors of the provider rules. For example, a person may use the highlight function in Microsoft® Word® to highlight text in a Word® document. Alternatively, the text of different information portions in digital record 148 may be modified using user interface 62 such that the text of different information portions is in different colors. For example, a person may use the Font Color feature of Microsoft® Work® to apply different colors to different text (different information portions), wherein provider 44 (shown in Figure with 1) is configured to provide access to or distribute information portions based upon the particular colors of the text of a Word document. In yet other embodiments, interface 62 may be used to modify the text of digital record 148 using other non-substantive characteristics having associated provider rules implemented by provider 44 (shown in FIG. 1). The resulting digital record 48 having information portions 50 with different non-substantive characteristics corresponding to provider rules may be then used by association device 20 to selectively provide information portions 50 to different recipients.

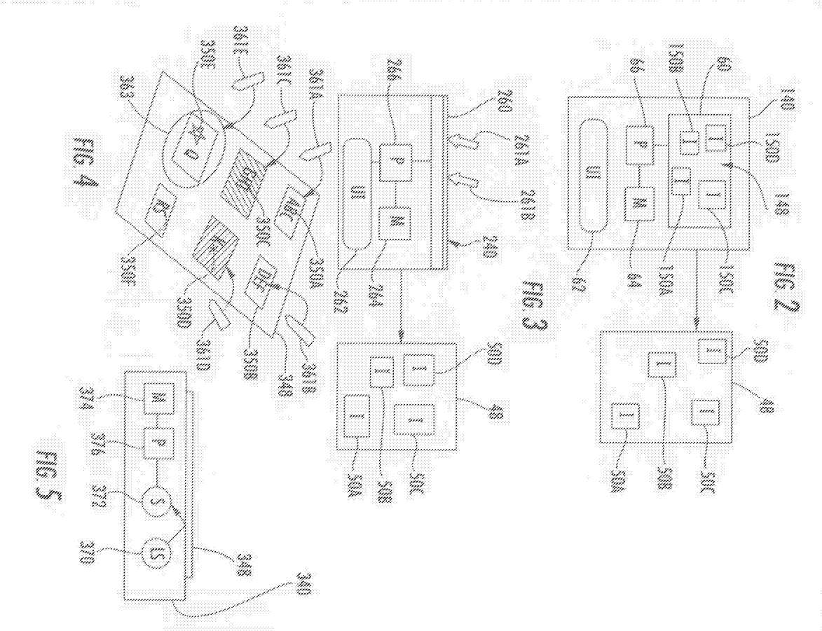

FIG. 3 schematically illustrates information capture component 240, another embodiment of information capture component 40. FIG. 3 further illustrates another method by which record 48 having information portions 50 with different associated non-substantive characteristics may be formed using information capture component 240. Informative capture component 240 comprises a sensing device including sensing surface 260, instruments 261A, 261B (collectively referred to as instruments 261), user interface 262, memory 264 and processing unit 266. Sensing surface 260 comprises a surface configured to generate signals in response to contact or other interaction with surface 260 by instruments 261. Such signals represent information being input to capture component 240 and stored in record 48. Examples of sensing surface 260 include a touchpad or touch screen.

Instrument 261 comprise devices configured to facilitate manual entry or input of information via a sensing surface 260. In one embodiment, instrument 261 comprises styluses or pens configured to be manually grasped and applied or pressed against sensing surface 260. Movement of instrument 261 along sensing surface 260 permits information to be input. In one embodiment, instruments 261A and instrument 261B are differently configured to create information portions having one more different non-substantive characteristics. For example, in one embodiment, instrument 261A may result in the storing of text or graphics in the first color while use of instrument 261B result in the storing of text or graphics in a second distinct color. In other embodiments, component 240 may include a singe instrument 261 for inputting different information portions having different non-substantive characteristics, wherein different non-substantive characteristics are associated with different information portions via a mode selection entered through user interface 262.

User interface 262 is configured to facilitate entry of commands or instructions from a person. User interface 262 is substantially similar to user interface 62 described above with respect to recipient 24. Memory 264 comprises a persistent storage device configured to store instructions for component 240 as well to store digital record 48 formed by component 240. Processing unit 266 comprises a processing unit configured to generate control signals for operation of surface 260, instruments 261. Processing unit 266 further stores input information in memory 264 to create digital record 48 having different information portions 50 with different associated non-substantive characteristics.

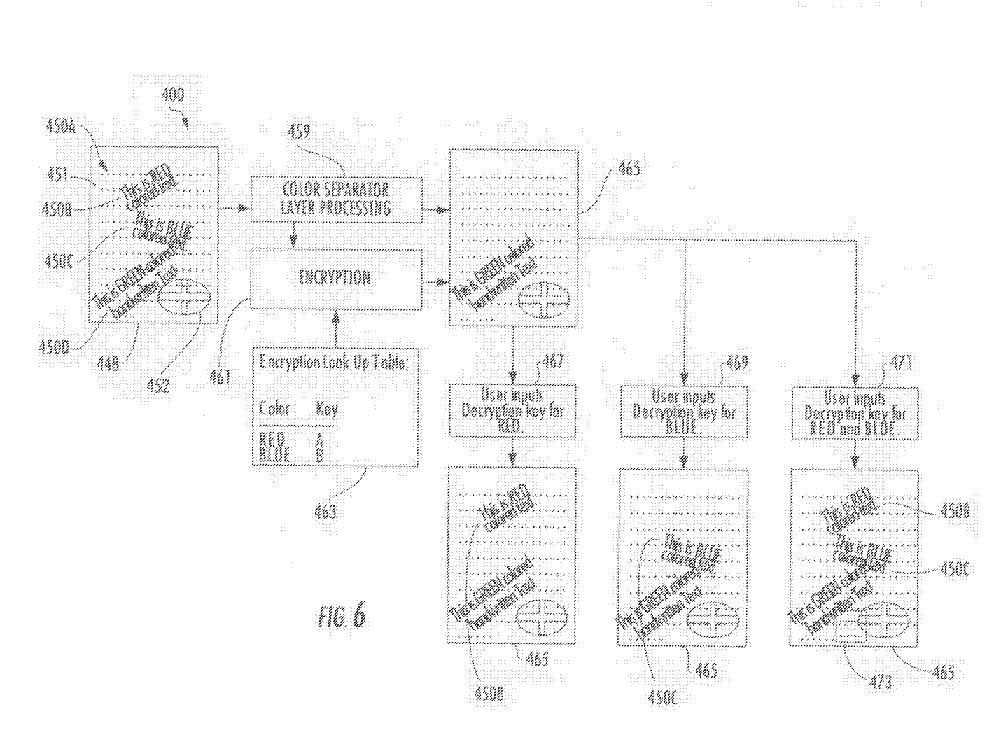

FIGS. 4 and 5 schematically illustrate another method by which a digital record 48 having different information portions 50 with different associated non-substantive characteristics corresponding to provider rules of provider 44 (shown in FIG. 1) may be formed. FIG. 4 illustrates a non-digital record 348, such as a sheet of paper or other material, upon which information portions 350A, 350B, 350C, 350D, 350E and 350F (collectively referred to as information portions 350) are written. Although such information portions 350 are schematically illustrated as being located at distinct separate areas upon record 348, such information portions 350 may alternatively be interleaved with one another.

As shown by FIG. 4, different non-substantive characteristics may be associated with or applied to different information portions 350. For example, information portion 350A is illustrated as being written with a first writing instrument 361A in a first color while information portions 350B is illustrated as being written with a second writing instrument 361B in a second distinct color. In other embodiments, information portion 350A may be written by writing instrument 361B as a second distinct line thickness. In other embodiments, other non-substantive characteristics may be written with information portions 350A and 350B. Information portion 350C is illustrated as being highlighted with a first color using highlighted instrument 361C while information portion 350D is illustrated as being highlighted with a second distinct color using highlighting instrument 361D. A shown by FIG. 4, information portion 350D includes both text and graphics. Information portion 350E is illustrated as being selected or identified with a marking 363 is illustrated as a circle, in other embodiments, selection mark 363 May comprise other markings such as squares, rectangles, ovals and the like. Such markings selecting different information portions may have the same color or may have different colors. Information portion 350F is different from each of the other information portions in that information portion 350F has no additional highlighting or marking. For example, information portion 350F may be written in black, a different color than information portions 350A and 350B. The highlighting of information portion or application of different selection marks to information portions 350 may be done to a pre-existing document after information of information portions 350 have already been written upon record 348.

FIG. 5 schematically illustrates capture component 340, another embodiment of capture component 40 (shown in FIG. 1). Capture component 340 comprises a device configured to sense or detect written text or graphics upon non-digital medium such as record 348. In one embodiment, capture component 340 comprises a scanner including light source 370, sensor 372, memory 374 and processing unit 376. Light source 370 is a source of light configured to direct or emit light towards record 348 facing light source 370. Sensor 372 comprises one or more sensors configured to sense light reflected off of record 348 and to generate signals based on such reflection. Memory 374 comprising persistent storage device configured to store operating instructions for processing unit 376 and to store formed digital record 48 (shown in FIG. 1). Processing unit 376 generates control signals following instructions contained in memory 374 for directing operation of component 340 and creates and stores digital records 48 based upon the signals from sensor 372. Although component 340 is illustrated as a flatbed scanner, in other embodiments, component 340 may comprise other types of scanners in which record 348 is moved relative to sensor 372. In still other embodiments, component 340 may comprise other devices configured to sense or capture information portions 350 written upon record 348.

FIG. 6 schematically illustrates one example process 400 that may be carried out by association device 20 (shown in FIG. 1). As shown by FIG. 6, information capture component 40 provides a digital record 448. Digital record 448 includes information portions 450A, 450B, 450C and 450D (collectively referred to as information portions 450). Information portion 450A comprises typed text 451 in a first color (black) extending generally from a top margin to a bottom margin of the document page. Information portion 450A further includes a graphic 452 in a second color (orange) in the lower right corner of the document page. Information portion 450A is authored by a first author. Information portion 450B comprises a hand written textual comment or note and a third distinct color (red) authored by a second author. Information portion 450C is a handwritten textual comment or note in a fourth distinct color (blue) written by a third author. In one embodiment, information portions 450D is hand written textual comment or note in a fifth distinct color (green) written by the second author in response to a note by the third author. In one embodiment, information portions 450 are initially written upon a non-digital medium, such as a sheet of paper, wherein the written upon non-digital medium is scanned to form data record 448.

As indicated by block 459, separator/identifier component 42 (shown in FIG. 1) senses or identifies the distinct colors of information portion 450. Such information portions are further separated and stored as different layers of the document by component 42.

As indicated by block 461, provider 44 (shown in FIG. 1) encrypts the different layers of information portion 450 based upon provider rules 463. In the example illustrated, provider rules 463 comprises an encryption lookup table designating how or whether different layers are to be encrypted. In the example illustrated, provider rules 463 establishes that information portions associated with the color red are to be encrypted with a first encryption scheme, wherein decryption or display of the associated information is in response to provision of encryption key A. Provider rules 463 establishes that information portions 450 associated with the color blue are to be encrypted with a second distinct encryption scheme, wherein the decryption or display of the associated information is in response to provision of encryption key B.

FIG. 6 further illustrates provider 44 selectively providing information portions 450 to different recipients. In particular, those information portions which have not been encrypted, information portions 450A and 450D, are provided to all designated recipients as indicated by information presentation 465, comprising a display or print out. As indicated by block 467, a first recipient may enter the decryption key A which results in information portion 450B being additionally included with presentation 465. As indicated by block 469, a second recipient may enter the decryption key B which in information portion 450C being additionally included with presentation 465. As indicated by block 471, a third recipient, having both decryption keys A and B may enter such decryption keys, wherein both information portions 450B and 450C are included with presentation 465. In such a manner, different recipients may be provided with access to different comments or notes of selected authors. In one embodiment, provider 44 may additionally be configured to generate an author index 473 as part of presentation 465, wherein the author index indicates the particular author with the particular comment or note. Such an index may be created based upon the colors associated with the particular comment of record 448.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
identifying different characteristics associated with different information portions; and
selectively distributing or providing access to the different information portions based upon the characteristics associated with the different information portions.

2. The method of claim 1, wherein the different characteristics are visible.

3. The method of claim 1, wherein the different characteristics are selected from a group of different characteristics consisting of: different fonts, different font styles, different font sizes, different font effects, different text effects, different character spacings, different handwriting, different dictation sound, or speed characteristics, different text colors or different text highlighting and combination thereof.

4. The method of claim 1, wherein selectively distributing comprises electronically transmitting the one or more portions to one or more recipients based on the different characteristics associated with each of the portions.

5. The method of claim 1 further comprising forming an index of authors of the portions based on the different characteristics associated with each of the portions.

6. The method of claim 1, wherein selectively providing access comprises encrypting the one or portions based on the different characteristics associated with each of the portions.

7. The method of claim 4, wherein the encrypting comprises applying different levels of encryption to the one or more portion based on the different characteristics associated with each of the portions.

8. The method of claim 4, wherein the encrypting comprises encrypting different portions such that different portions may be decrypted with different keys based on the different characteristics associated with each of the portions.

9. The method of claim 1, wherein the different characteristics comprise different colors associated with different information portions.

10. The method of claim 9, wherein the information portions are surrounded by the colors.

11. The method of claim 9, wherein the different characteristics comprise the different information portions based upon their different colors.

12. The method of claim 1 further comprising separately storing the information portions based upon their different characteristics.

13. The method of claim 1, wherein identifying comprises scanning a surface having the different information portions.

14. The method of claim 13, wherein of the surface is a sheet of a medium.

15. The method of claim 12 further comprising, receiving manually applied markings of the different information portions or their associated characteristics on a display sensing surface, wherein identifying comprises sensing the manually applied markings.

16. The method of claim 1, wherein identifying comprises detecting a first information portion having a first color and detecting a second information portion having a second color and wherein the method further comprises:
storing the first portion in a memory;
storing the second portion in a memory;
presenting the first portion in response receiving a first authorization; and
presenting the second portion in response receiving a second authorization.

17. The method of claim 1, wherein the different characteristics comprise different colors and wherein the method further comprises assigning the different colors to the different information portions by writing the information portions in the different colors or by highlighting the different information portions in different colors.

18. The method of claim 17, wherein the different information portions are written upon a sheet.

19. An apparatus comprising:
An identifier configured to detect different colors assigned to different information portions; and
a processing unit configured to:
associate the different colors with the different information portions; and
selectively distribute or selectively provide access to the different information portions based upon the colors associated with the different information portions.

20. A method comprising:
detecting different colors associated with different information portions; and
selectively distributing or providing access to the different information portions based upon the colors associated with the different information portions.
